(19) United States
(12) Patent Application Publication
(10) Pub. No.: US 2009/0153749 A1
(43) Pub. Date: Jun. 18, 2009

(54) Portable projector background color correction scheme

(76) Inventor: Stephen Randall Mixon, Painted Post, NY (US)

Correspondence Address: CORNING INCORPORATED, SP-TI-3-1, CORNING, NY, 14831, US

(21) Appl. No.: 12/002,206

(22) Filed: Dec. 14, 2007

(51) Int. Cl. H04N 9/31

(52) U.S. Cl. 348/744; 348/E09.025

(57) ABSTRACT

According to one embodiment of the present invention, a method of controlling an image projector comprising a multi-color laser source, projection optics, an image sensor, and a movement detection device comprises the projection of an image onto a display surface with the image projector. During projection, a movement signal generated by movement detection device is monitored, the movement signal indicating positional displacement of the image projector. A test pattern image is projected onto the display surface using the image projector, wherein the test pattern image projection is initiated as a function of the monitored movement signal. Thereafter, the projected test pattern image is captured from the display surface using the image sensor. A comparison of projected test pattern image data and captured test pattern image data is used to modify the manner in which subsequent images are projected to correct color distortions represented in the captured test pattern image.

### BACKGROUND

Embodiments of the present invention relate to methods of controlling image projectors, and, more particularly, to methods of controlling image projectors to correct color distortions in projected images.

### SUMMARY

According to one embodiment of the present invention, a method of controlling an image projector comprising a multi-color laser source, projection optics, an image sensor, and a movement detection device comprises projecting an image onto a display surface using the multi-color laser source and the projection optics. The method also comprises monitoring a movement signal generated by the movement detection device, wherein the movement signal is indicative of positional displacement of the image projector and projecting a test pattern image onto the display surface using the multi-color laser source and the projection optics, wherein the test pattern image projection is initiated as a function of the monitored movement signal. Thereafter, the method comprises capturing the projected test pattern image from the display surface using the image sensor and utilizing a comparison of projected test pattern image data and captured test pattern image data to modify the manner in which subsequent images are projected using the multi-color laser source and the projection optics of the image projector to correct color distortions represented in the captured test pattern image.

The present invention is not to be limited to the particular embodiment provided above or the other embodiments described herein. It is contemplated that additional embodiments are possible through modifications and variations to the embodiments described. Such modifications and variations are permissible without departing from the scope of the invention described in the specification and defined in the appended claims.

### BRIEF DESCRIPTION OF THE DRAWINGS

It is believed that embodiments of the present invention will be better understood from the following description taken in conjunction with the accompanying drawings in which:

FIG. 1 is a schematic illustration depicting an image projector;

FIG. 2 is an illustration depicting an image frame; and

FIG. 3 is a flowchart depicting a method of controlling an image projector.

The embodiments set forth in the drawings are illustrative in nature and are not intended to be limiting of the invention defined by the claims. Moreover, individual aspects of the drawings and the invention will be more fully apparent and understood in view of the detailed description.

### DETAILED DESCRIPTION

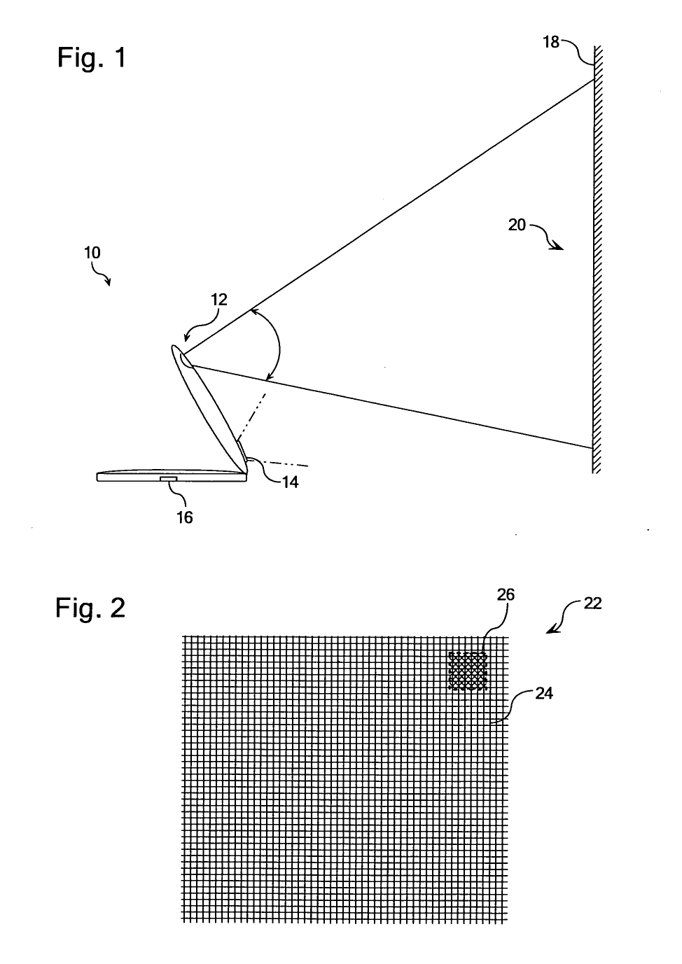

Referring initially to the schematic illustration of FIG. 1, an image projector 10 according to one embodiment of the present invention is illustrated. The image projector comprises a multi-color laser source and projection optics 12, an image sensor 14, and a movement detection device 16. Typically, the image projector 10 also comprises a programmable controller configured to issue commands for the operation of the various components of the image projector 10, as is described herein. In one embodiment, the image projector resides in a portable platform. Here, the multi-color laser source, the projection optics 12, the image sensor 14, and the movement detection device 16 of the image projector 10 are mechanically coupled to the portable platform. As shown schematically in FIG. 1, the portable platform may reside in a mobile telephone.

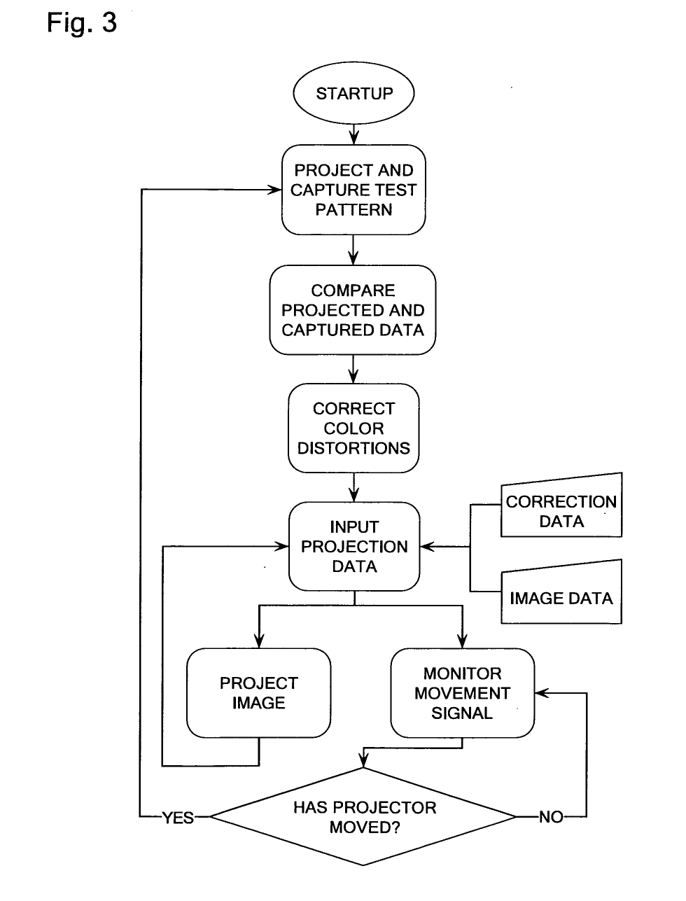

FIG. 3 presents an embodiment of a method of controlling an image projector 10, such as that illustrated in FIG. 1. The illustrated method comprises projecting an image 20 onto a display surface 18 using the multi-color laser source and projection optics 12 of the image projector 10. As shown in FIGS. 1 and 2, the image 20 may be projected onto the display surface 18 by scanning multiple beams of the multi-color laser source 12 across an image frame 22. The multi-color laser source 12 may provide the multiple beams in various colors and intensities, such as, but not limited to, red, green, and blue colors and combinations thereof or in cyan, magenta, yellow, and black colors and combinations thereof. The image 20 may be projected onto the display surface 18 by generating a plurality of successive image frames 22. As shown in FIG. 2, each image frame 22 generally is comprised of one or more picture elements 24, which can be grouped into sets of multiple adjacent picture elements 26. In one embodiment, the image 20 is projected onto the display surface 18 using projection optics comprising a multi-axis scanning mirror. It is contemplated, however, that the method, or color correction scheme, described herein may be applied to any method of projection, whether through multi-axis scanning or otherwise.

Returning again to the flow chart of FIG. 3, the illustrated method further comprises monitoring a movement signal generated by the movement detection device 16 of the image projector 10. This monitoring of the movement signal is performed by the image projector 10 simultaneously with the projecting of the image 20 onto the display surface 18. More particularly, the movement detection device 16 generates a movement signal that is indicative of positional displacement of the image projector 10 as the image projector 10 projects the image 20 onto the display surface 18. The movement detection device may be an accelerometer, a component that cooperates with a global positioning system, or any other conventional or yet to be developed device that can generate a signal providing some indication of positional displacement of the projector 10.

The aforementioned movement signal is monitored to determine the positional displacement of the image projector 10. In one embodiment, the movement detection device 16 is configured to generate a movement signal that comprises a range of values indicating the degree of positional displacement of the image projector 10. For example, a positional displacement value generated by the movement detection device 16 may be equal to zero, indicating that the image projector is stationary, or may be some value greater than zero, indicating that the image projector 10 has been, or is being, displaced from a previous stationary position in one of any variety of forms and/or distances of displacement, according to the definitions assigned to the potential numbers of the displacement value. Forms of displacement, for example, can include vibrations, rotations, angulations, or other movement, while distances of displacement can be any measurement of length.

In another embodiment, the movement detection device 16 is configured to generate a movement signal that more simply indicates that the projector 10 is either stationary or has moved. In which case, the positional displacement indicated by the movement signal comprises either a stationary value indicating a stationary image projector or a displaced value indicating a displaced image projector. For example, the stationary value may be equal to zero, while a displaced value may be equal to one, meaning that the image projector has moved in some form of movement.

As shown in FIG. 3, when the movement signal indicates that the image projector 10 is stationary, the image projector 10 continues projecting the image onto the display surface 18. When, however, the movement signal indicates that the image projector 10 has moved, or is moving, the method further comprises projecting a test pattern image onto the display surface 18 using the multi-color laser source and the projection optics 12. Thus, the projection of a test pattern image is initiated as a function of the monitored movement signal. For example, when the monitored movement signal indicates positional displacement, or a degree thereof, of the image projector 10, then the test pattern image projection may be initiated. As used herein, “test pattern image” refers to any image or image frame generated and projected that can be used to evaluate and modify the projection of subsequent images projected by the image projector 10. The test pattern image may be identical to, some variation of, or entirely different from a previous image or image frame projected by the image projector 10. Further, the test pattern image may comprises a compilation of image elements that is substantially uniform in color or may define a varying color distribution. As is the case with standard projection, the test pattern image may be projected onto the display surface 18 by scanning one or more beams of the multi-color laser source 12 across a test pattern image frame, which may or may not be contiguous with the standard projection frame.

Following the projection of the test pattern image, the test pattern image can be captured from the display surface 18 using the image sensor 14. The image sensor 14, shown in FIG. 1, may be a camera, a charge-coupled detector, or any other image sensing device configured to capture light intensity and color from a display surface. Typically, the projected test pattern image is captured as a compilation of picture elements or as a single image representing an average color and intensity of the test pattern image.

After the projected test pattern image has been captured by the image sensor 14, a comparison of projected test pattern image data and captured test pattern image data is utilized to modify the manner in which subsequent images are projected with the image projector 10 to correct color distortions represented in the captured test pattern image. Projection data used to project an image 20, and any subsequent images, is derived from a combination of image data and correction data. The image data is particular to the image 20 to be projected and the correction data is derived from the comparison of the projected test pattern image data and the captured test pattern image data.

In one embodiment, the manner in which the subsequent images are projected can be modified by using the comparison of the projected test pattern image data and the captured test pattern image data to generate a table of offset color intensity values. This table of offset color intensity values may serve as the correction data described above. The offset color intensity values are added to or subtracted from the color intensity values of corresponding picture elements so as to correct the color distortions represented in the captured test pattern image.

In one embodiment, the projected test pattern image data and the captured test pattern image data are compared on an element-by-element basis. Thereafter, the manner in which the subsequent images are projected by the image projector can be modified on an element-by-element basis.

In another embodiment, the projected test pattern image data and the captured test pattern image data are compared by referring collectively to multiple adjacent picture elements in the test pattern image. Thereafter, the manner in which the subsequent images are projected can be modified by modifying multiple adjacent picture elements collectively in the subsequent images.

In yet another embodiment, the projected test pattern image data and the captured test pattern image data are compared by referring to sub-divided picture elements in the test pattern image. Thereafter, the manner in which the subsequent images are projected can be modified by modifying sub-divided picture elements in the subsequent images.

In yet even another embodiment, the projected test pattern image data and the captured test pattern image data are compared by referring to an average color intensity value of the test pattern image. Thereafter, the manner in which the subsequent images are projected can be modified by modifying an average color intensity value in the subsequent images. For example, this can be achieved by modifying an average color intensity value defined by a plurality of color intensity values of a plurality of picture elements or by modifying an average color intensity value defined by substantially all of the color intensity values of substantially all of the picture elements.

Of course, it is contemplated that if the projected test pattern image data and the captured test pattern image data are identical, then no modification of the manner in which subsequent images are projected is necessary. Under such circumstances, the image projector may continue projecting images without modifying their projection.

As is illustrated in FIG. 3, the above-described steps for correcting color distortions can also be initiated during projector 10 startup.

While one particular color correction scheme has been described herein, the concepts of the present invention that relate to the manner in which color correction of image projection is initiated are not limited to any particular color correction scheme. More particularly, it contemplated that various other color correction schemes may be initiated through embodiments of the method described herein. For example, the color correction schemes described in U.S. Pat. No. 6,814,448 to loka, U.S. Patent Application No. 2007/0154086 by Sung-Dae Cho, U.S. Patent Application No. 2004/0070565 by Nayar, and U.S. Patent Application No. 2007/0091334 by Yamaguchi may be initiated by various embodiments of the method described in the present application.

It is noted that recitations herein of a component of the present invention being “configured” in a particular way, “configured” to embody a particular property or function in a particular manner, are structural recitations as opposed to recitations of intended use. More specifically, the references herein to the manner in which a component is “configured” denotes an existing physical condition of the component and, as such, is to be taken as a definite recitation of the structural characteristics of the component.

It is noted that terms like “generally” and “typically,” when utilized herein, are not utilized to limit the scope of the claimed invention or to imply that certain features are critical, essential, or even important to the structure or function of the claimed invention. Rather, these terms are merely intended to identify particular aspects of an embodiment of the present invention or to emphasize alternative or additional features that may or may not be utilized in a particular embodiment of the present invention.

For the purposes of describing and defining the present invention it is noted that the term “substantially” is utilized herein to represent the inherent degree of uncertainty that may be attributed to any quantitative comparison, value, measurement, or other representation. The term “substantially” is also utilized herein to represent the degree by which a quantitative representation may vary from a stated reference without resulting in a change in the basic function of the subject matter at issue.

Having described the invention in detail and by reference to specific embodiments thereof, it will be apparent that modifications and variations are possible without departing from the scope of the invention defined in the appended claims. More specifically, although some aspects of the present invention may be identified herein as preferred, particularly advantageous, or desirable it is contemplated that the present invention is not necessarily limited to these preferred aspects of the invention.

It is noted that one or more of the following claims utilize the term “wherein” as a transitional phrase. For the purposes of defining the present invention, it is noted that this term is introduced in the claims as an open-ended transitional phrase that is used to introduce a recitation of a series of characteristics of the structure and should be interpreted in like manner as the more commonly used open-ended preamble term “comprising.”

What is claimed:

1. A method of controlling an image projector comprising a multi-color laser source, projection optics, an image sensor, and a movement detection device, the method comprising:
projecting an image onto a display surface using the multi-color laser source and the projection optics of the image projector;
monitoring a movement signal generated by the movement detection device, wherein the movement signal is indicative of positional displacement of the image projector;
projecting a test pattern image onto the display surface using the multi-color laser source and the projection optics, wherein the test pattern image projection is initiated as a function of the monitored movement signal;
capturing the projected test pattern image from the display surface using the image sensor; and
utilizing a comparison of projected test pattern image data and captured test pattern image data to modify the manner in which subsequent images are projected using the multi-color laser source and the projection optics of the image projector to correct color distortions represented in the captured test pattern image.

2. The method of claim 1, wherein:
the image is projected onto the display surface by scanning multiple beams of the multi-color laser source across an image frame, and
the image is projected by generating a plurality of successive image frames.

3. The method of claim 1, wherein projection data used to project the image and the subsequent images is derived from a combination of image data particular to the image to be projected and correction data derived from the comparison of the projected test pattern image data and the captured test pattern image data.

4. The method of claim 1, wherein the positional displacement indicated by the movement signal comprises a range of values indicating a degree of positional displacement of the image projector.

5. The method of claim 1, wherein the positional displacement indicated by the movement signal comprises either a stationary value indicating a stationary image projector or a displaced value indicating a displaced image projector.

6. The method of claim 1, wherein the test pattern image is projected onto the display surface by scanning one or more beams of the multi-color laser source across a test pattern image frame.

7. The method of claim 1, wherein the test pattern image comprises a compilation of image elements that is substantially uniform in color or defines a varying color distribution.

8. The method of claim 1, wherein:
the test pattern image is projected as a compilation of picture elements; and
the projected test pattern image is captured as a compilation of picture elements.

9. The method of claim 8, wherein the projected test pattern image data and the captured test pattern image data are compared on an element-by-element basis.

10. The method of claim 9, wherein the manner in which the subsequent images are projected is modified on an element-by-element basis.

11. The method of claim 8, wherein the projected test pattern image data and the captured test pattern image data are compared by referring collectively to multiple adjacent picture elements in the test pattern image.

12. The method of claim 11, wherein the manner in which the subsequent images are projected is modified by modifying multiple adjacent picture elements collectively in the subsequent images.

13. The method of claim 8, wherein the projected test pattern image data and the captured test pattern image data are compared by referring to sub-divided picture elements in the test pattern image.

14. The method of claim 13, wherein the manner in which the subsequent images are projected is modified by modifying sub-divided picture elements in the subsequent images.

15. The method of claim 8, wherein the projected test pattern image data and the captured test pattern image data are compared by referring to an average color intensity value of the test pattern image.

16. The method of claim 15, wherein the manner in which the subsequent images are projected is modified by modifying an average color intensity value in the subsequent images.

17. The method of claim 1, wherein the manner in which the subsequent images are projected is modified by using the comparison of the projected test pattern image data and the captured test pattern image data to generate a table of offset color intensity values.

18. The method of claim 17, wherein the offset color intensity values are added to or subtracted from the color intensity values of corresponding picture elements so as to correct the color distortions represented in the captured test pattern image.

19. The method of claim 1, wherein the manner in which the subsequent images are projected is modified on an element-by-element basis.

20. The method of claim 1, wherein the manner in which the subsequent images are projected is modified by modifying sub-divided picture elements in the subsequent images.

21. The method of claim 1, wherein the manner in which the subsequent images are projected is modified by modifying an average color intensity value defined by a plurality of color intensity values of a plurality of picture elements.

22. The method of claim 1, wherein the manner in which the subsequent images are projected is modified by modifying an average color intensity value defined by substantially all of the color intensity values of substantially all of the picture elements.

23. The method of claim 1, wherein:
the multi-color laser source, the projection optics, the image sensor, and the movement detection device of the image projector are mechanically coupled to a common portable platform, and
the portable platform resides in a mobile telephone.

24. An image projector comprising a multi-color laser source, projection optics, an image sensor, a movement detection device, and a programmable controller collectively configured to:
project an image onto a display surface using the multi-color laser source and the projection optics of the image projector;
monitor a movement signal generated by the movement detection device, wherein the movement signal is indicative of positional displacement of the image projector;
project a test pattern image onto the display surface using the multi-color laser source and the projection optics, wherein the test pattern image projection is initiated as a function of the monitored movement signal;
capture the projected test pattern image from the display surface using the image sensor; and
utilize a comparison of projected test pattern image data and captured test pattern image data to modify the manner in which subsequent images are projected using the multi-color laser source and the projection optics of the image projector to correct color distortions represented in the captured test pattern image.

25. The image projector of claim 24, wherein:
the image projector resides in a portable platform to which the multi-color laser source, the projection optics, the image sensor, and the movement detection device of the image projector are mechanically coupled, and
the portable platform resides in a mobile telephone.
